(19) United States
(12) Patent Application Publication
(10) Pub. No.: US 2007/0242855 A1
(43) Pub. Date: Oct. 18, 2007

(54) Target searching device and its image display method

(76) Inventor: Tony K.T. Chen, Dasi Township (TW)

Correspondence Address: Raymond Sun, 12420 Woodhall Way, Tustin, CA, 92782, US

(21) Appl. No.: 11/499,933

(22) Filed: Aug. 7, 2006

(30) Foreign Application Priority Data
Apr. 14, 2006 (TW) 95113305

(51) Int. Cl. G06K 9/00

(52) U.S. Cl. 382/103

(57) ABSTRACT

A target searching device has an image capture unit that captures and outputs a captured image having I×J pixels, an image display unit that displays a displayed image having M×N pixels, and an image process unit that is coupled with the image capture unit and the image display unit. The target searching device can perform a method of displaying an image, which includes the steps of acquiring a captured image having I×J pixels, selecting a pre-set target from the captured image, dividing the captured image into a plurality of image blocks with reference to the pre-set target, resealing each image block by a set of zoom parameters to transform the captured image of I×J pixels into a displayed image having M×N pixels, and displaying the displayed image.

### BACKGROUND OF THE INVENTION

1. Field of the Invention

The present invention relates to a target searching device, and in particular, to a target searching device and an image display method which can enhance the target part of the image.

2. Description of the Prior Art

Target searching devices are assistive devices used by users to search for viewing a target or aiming at a target. For example, a telescope is usually used to search for and view distant objects. Similarly, the sight on a weapon is used to assist shooters to search for and aim at desired targets for shooting.

A conventional electronic telescope or sight is equipped with an image capture unit to capture the target image, and an image display unit to display the image captured. The pixels of the image displayed in the image display unit are usually less than that of the image captured in the image capture unit. Consequently, when the image captured in the image capture unit is displayed in the image display unit, the image has to be reduced by a predefined factor in order to be fully displayed in the image display unit. However, displaying the reduced image will render the image smaller and thereby make it more difficult to search. Also, if the image captured is not reduced, only part of the image captured can be displayed, and the search of a target can be rendered equally difficult.

### SUMMARY OF THE DISCLOSURE

It is an object of the present invention is to provide a target searching device and a display method which can selectively enhance the target part of an image to facilitate the search of the target in the image.

In order to accomplish the objects of the present invention, the present invention provides a method of displaying an image, which includes the steps of acquiring a captured image having I×J pixels, selecting a pre-set target from the captured image, dividing the captured image into a plurality of image blocks with reference to the pre-set target, resealing each image block by a set of zoom parameters to transform the captured image of I×J pixels into a displayed image having M×N pixels, and displaying the displayed image.

The present invention also provides a target searching device that has an image capture unit that captures and outputs a captured image having I×J pixels, an image display unit that displays a displayed image having M×N pixels, and an image process unit that is coupled with the image capture unit and the image display unit. The image process unit receives the captured image from the image capture unit, selects a pre-set target from the captured image, and divides the captured image into a plurality of image blocks with reference to the pre-set target. The image process unit then rescales each image block with reference to a set of zoom parameters to transform the captured image of I×J pixels into the displayed image of M×N pixels, which can be displayed by the image display unit.

### BRIEF DESCRIPTION OF THE DRAWINGS

FIG. 1 is a schematic block diagram of one embodiment of a target searching device according to the present invention.

FIG. 2 is a flow chart of one embodiment of the image display method of a target searching device according to the present invention.

FIG. 3 is an example of the output image of the image capture unit in FIG. 1.

FIG. 4 is a scaled down image in proportion to the image in FIG. 3.

FIG. 5 is a transformation of the image in FIG. 3 by the image process unit in FIG. 1.

FIG. 6 is an example of another output image of the image capture unit in FIG. 1.

FIG. 7 is a scaled down image in proportion to the image in FIG. 6.

FIG. 8 is a transformation of the image in FIG. 6 by the image process unit in FIG. 1.

FIG. 9 illustrates the image transformed from the image in FIG. 3 by a polar coordinate.

FIG. 10 illustrates the image transformed from the image in FIG. 6 by a polar coordinate.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

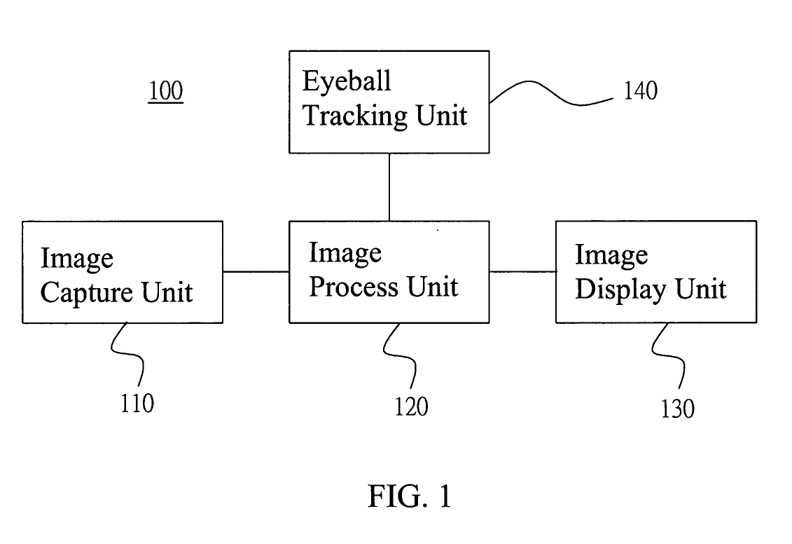

Referring to FIG. 1, a target searching device 100 according to one embodiment of the present invention includes an image capture unit 110, an image process unit 120, an image display unit 130, and an eyeball tracking unit 140, with the image process unit 120 coupled with the image capture unit 110, the image display unit 130, and the eyeball tracking unit 140, respectively. The eyeball tracking unit 140 is optional and can be omitted if the selection of the pre-set target does not refer to the output of the eyeball tracking unit 140.

The image capture unit 110 can be an image sensor, such as Charge Coupled Device (CCD) or Complementary Metal Oxide Semiconductor (CMOS), for capturing distant target images and outputting an image having I×J pixels.

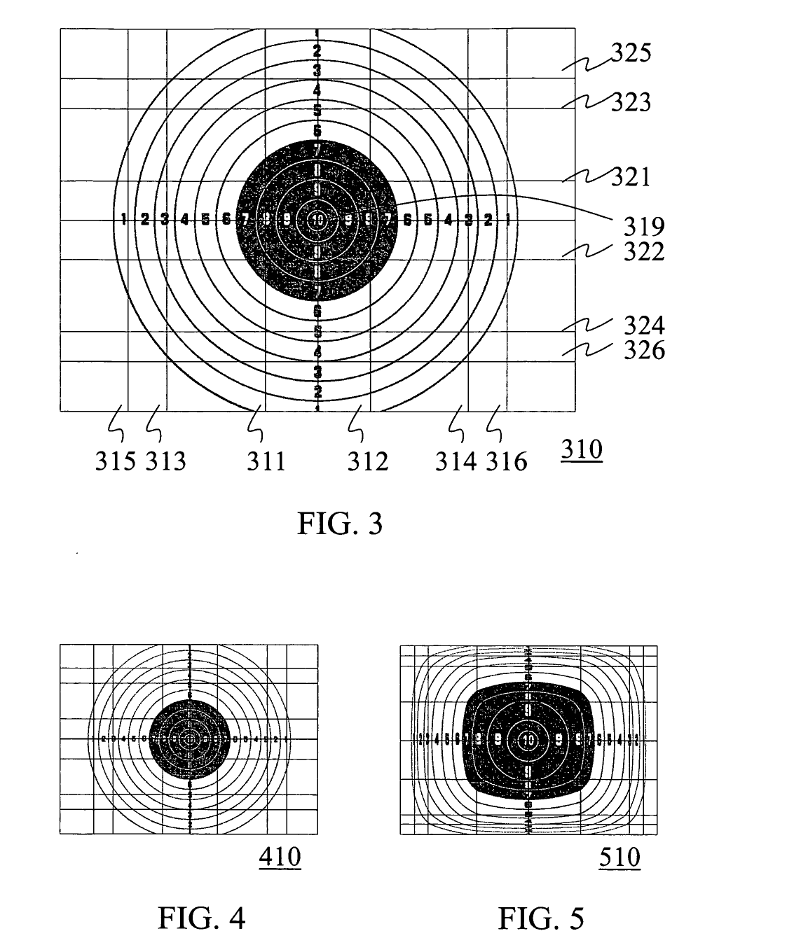

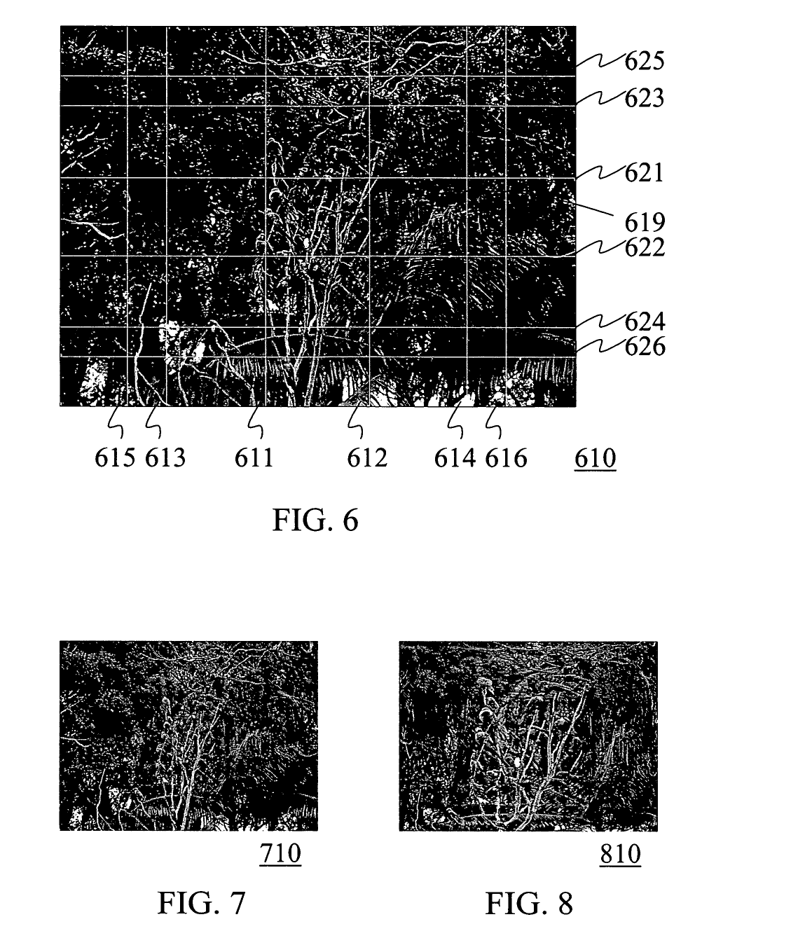

In the present embodiment, the output image 310 (FIG. 3) or 610 (FIG. 6) from the image capture unit 110 can have 1280×960 pixels, for example. However, the image which can be displayed by the image display unit 130 has only 640×480 pixels. Consequently, it is necessary to scale down the image of the 1280×960 pixels in proportion by a factor of 4 into that of 640×480 pixels, so that the image 310 (FIG. 3) or the image 610 (FIG. 6) can be fully displayed as image 410 (FIG. 4) or image 710 (FIG. 7), respectively. However, this will significantly decrease the size of the pre-set targets of the images 410 and 710, and thereby adversely affect the search of targets.

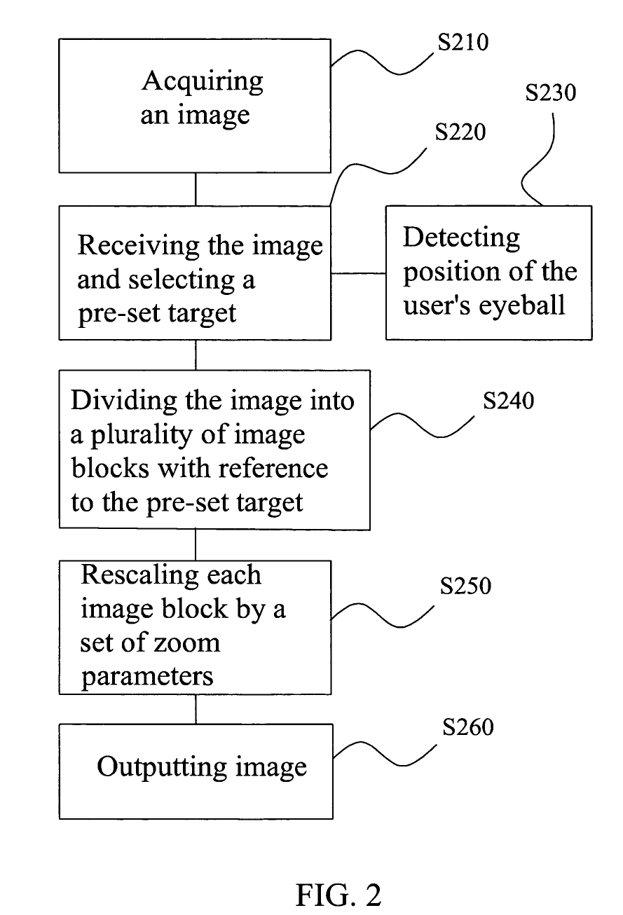

Consequently, the target searching device 100 in FIG. 1 uses the image display method shown in FIG. 2 to transform the image 310 or 610 having 1280×960 pixels into the image of 510 (FIG. 5) or 810 (FIG. 8) having 640×480 pixels, respectively. The transformation of the image display method is described in details as follows.

First, in step S210, the image capture unit 110 captures a distant image 310 or 610. In step S220, the image process unit 120 receives the image 310 or 610 from the image capture unit 110, and selects a pre-set target 319 or 619 in the image 310 or 610 according to the user's decision. The pre-set target 319 or 619 can also be determined in step S230, in which the position of the user's eyeball is detected by the eyeball tracking unit 140. The pre-set target 319 or 619 selected by the user is assumed here to be at the center of the image 310 or 610.

Next, in step S240, the selected pre-set target 319 or 619 is taken as the center to divide the image 310 or 610 into multiple image blocks. In the present embodiment, for example, the image 310 or 610 is drawn with vertical lines 311, 312, 313, 314, 315 and 316, or 611, 612, 613, 614, 615 and 616, on both sides of the pre-set target 319 or 619, respectively, and horizontal lines 321, 322, 323, 324, 325 and 326, or 621, 622, 623, 624, 625 and 626 on the both sides of the pre-set target 319 or 619, respectively, to form multiple rectangular image blocks.

Next, in step S250, each image block is magnified or reduced by a set of zoom parameters to transform the image of I×J pixels into that of M×N pixels. As an example, take the transformation of the image 310 or 610 (which have 1280×960 pixels) into that of image 510 or 810 (which have 640×480 pixels). The positions of the vertical lines 311 and 312 are located by extending 134 pixels leftward and rightward from the pre-set target 319 of the image 310. Similarly, the positions of the vertical lines 611 and 612 are located by extending 134 pixels leftward and rightward from the pre-set target 619 of the image 610. In a similar manner, the positions of the vertical lines 313 and 314 (or 613 and 614) are located by extending 240 pixels leftward and rightward from vertical lines 311 and 312 (or 611 and 612). In addition, the positions of the vertical lines 315 and 316 (or 615 and 616) are located by extending 96 pixels leftward and rightward from the vertical lines 313 and 314 (or 613 and 614).

The horizontal lines are adjusted in a similar manner. For example, the positions of the horizontal lines 321 and 322 (or 621 and 622) are located by extending 100 pixels from the pre-set target 319 (or 619) of the image 310 (or 610) upward and downward. The positions of the horizontal lines 323 and 324 (or 623 and 624) are located by extending 180 pixels upward and downward from the horizontal lines 321 and 322 (or 621 and 622). The positions of the horizontal lines 325 and 326 (or 625 and 626) are located by extending 75 pixels upward and downward from the horizontal lines 323 and 324 (or 623 and 624).

Consequently, the image 310 is divided into 49 rectangular image blocks by the vertical lines 311, 312, 313, 314, 315, 316, the horizontal lines 321, 322, 323, 324, 325, 326 and the boundaries of the image 310. Similarly, the image 610 is divided into 49 rectangular image blocks by the vertical lines 611, 612, 613, 614, 615, 616, the horizontal lines 621, 622, 623, 624, 625, 626, and the boundaries of the image 610. The rectangular image blocks are magnified or reduced by a zoom parameter along the transverse axis and a zoom parameter along the longitudinal axis such that the image 510 or 810 is transformed and becomes an image of 640×480 pixels, in the manner described below.

The rectangular image blocks bordered by the vertical lines 311, 312 and the horizontal lines 321 and 322 (or the vertical lines 611, 612 and the horizontal lines 621 and 622) contain the pre-set target of the image 319 (or 619). To maintain the clarity of the present image blocks, the zoom factor of the zoom parameter for the present image block can be set to be 1 along both the transverse and longitudinal axes. Consequently, the zoom factor of the zoom parameter is 1 for the rectangular image block bordered by the vertical lines 311, 312 (or 611, 612) along the transverse axis, and the zoom factor of the zoom parameter is 1 for the rectangular image block bordered by the horizontal lines 321, 322 (or 621, 622) along the longitudinal axis.

Moreover, the zoom factor of the zoom parameter along the transverse axis can be half (i.e., ½) for the rectangular image blocks bordered by the vertical lines 311 and 313, and for the image blocks bordered by the vertical lines 312 and 314. Similarly, the zoom factor of the zoom parameter along the transverse axis can be half (i.e., ½) for the rectangular image blocks bordered by the vertical lines 611 and 613, and for the image blocks bordered by the vertical lines 612 and 614.

The zoom factor of the zoom parameter along the transverse axis can be one-third (i.e., ⅓) for the rectangular image blocks bordered by the vertical lines 313 and 315 (or 613 and 615), and for the image blocks bordered by the vertical lines 314 and 316 (or 614 and 616).

The zoom factor of the zoom parameter along the transverse axis can be ⅕ for the rectangular image blocks bordered by the vertical line 315 and the boundary (or the vertical line 615 and the boundary in FIG. 6), and for the image blocks bordered by the vertical line 316 and the boundary (or the vertical line 616 and the boundary in FIG. 6).

Furthermore, the zoom factor of the zoom parameter along the longitudinal axis can be half (i.e., ½) for the rectangular image blocks bordered by the horizontal lines 321 and 323 (or the horizontal lines 621 and 623), and for the image blocks bordered by the horizontal lines 322 and 324 (or the horizontal lines 622 and 624).

The zoom factor of the zoom parameter along the longitudinal axis can be one third (i.e., ⅓) for the rectangular image blocks bordered by the horizontal lines 323 and 325 (or the horizontal lines 623 and 625), and for the image blocks bordered by the horizontal lines 324 and 326 (or the horizontal lines 624 and 626). Also, the zoom factor of the zoom parameter along the longitudinal axis can be ⅕ for the rectangular image blocks bordered by the horizontal line 325 and the boundary of FIG. 3 (or the horizontal line 625 and the boundary of FIG. 6), and for the image blocks bordered by the horizontal line 326 and the boundary of FIG. 3 (or the horizontal line 626 and the boundary of FIG. 6).

Various operations of image processing can be used to magnify or reduce images. Different operations will result in different effects of image transformation. According to one non-limiting embodiment of the present invention, a simple pixel-removal operation is used to achieve the image reduction. For example, to reduce the image along the transverse or longitudinal axis to half, one out of every two pixels along the transverse or longitudinal axis is removed. Similarly, to reduce the image along the transverse or longitudinal axis to one-third, two out of every three pixels along the transverse or longitudinal axis are removed. Also, to reduce the image along the transverse or longitudinal axis to ⅕, for example, four out of every five pixels along the transverse or longitudinal axis are removed.

Finally, in step S260, the display image 510 or 810 after transformation is output and displayed in the image display unit 130 so that the image 310 or 610 output from the image capture unit 110 can be fully displayed. Although some distortion will occur in the images 510 or 810 after transformation, the rectangular image block containing the pre-set target 319 or 619 has been enhanced along with the full display of the image captured. Consequently, the user can easily change the location of the pre-set target 319 or 619 and find the desired target. The search for a target is therefore not affected by the reduction of the pre-set target 319 or 619, or an incomplete image.

The embodiment described above divides the image 310 or 610 into 49 rectangular image blocks, and reduces the image blocks by a factor of 1, half (½), one-third (⅓), and ⅕, respectively, from the center along the transverse and longitudinal axes to achieve the image transformation. It is also possible to increase the number of the divisions of the image blocks and to apply a gradual change of the zoom parameter for the transformation of the displayed image such that the distortion of image can be reduced. Also, the number of the division of the image blocks and the zoom parameter can also be set according to the requirements of different display images to render the image after transformation more consistent to the user's actual demands. For example, applying the factors of 1, ⅘, ⅗, ⅖ and ⅕ (in this sequential order) from the center of the image will provide a smoother zoom parameter for the transformation of the displayed image, and will reduce the distortion of the image.

Furthermore, to clearly display the pre-set target 319 or 619, the zoom factor can be set to be larger than 1 for the innermost image block(s) containing the pre-set target 319 or 619, while further reducing the other image blocks to achieve the same transformation of image pixels. This practice will further enhance the image of the pre-set target 319 or 619.

While the division and magnification or reduction of the image 310 or 610 can be achieved by using the transverse and longitudinal axes of the rectangular coordinate as the reference axes, other approaches are also possible. For example, polar coordinates can be used to divide the image 310 or 610 into a plurality of non-rectangular image blocks. A different set of zoom parameters along different coordinate axes will be applied for each non-rectangular image block for magnification or reduction. An image of I×J pixels can also be transformed into an image of M×N pixels.

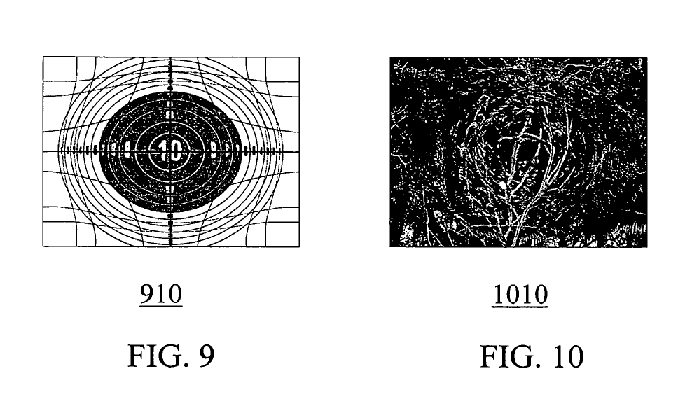

In FIGS. 9 and 10, a plurality of radiating lines are drawn by taking the pre-set target 319 or 619 of the image 310 or 610, respectively, as the center, and then a plurality of concentric ovals are drawn to encircle the pre-set target 319 or 619 such that a plurality of fan-shaped image blocks are formed. Each fan-shaped image block is applied with a set of zoom parameters for magnification or reduction to transform the image 310 or 610 of 1280×960 pixels into the image 910 or 1010 of 640×480 pixels. To maintain the image clarity of the image around the pre-set target 319 or 619, the zoom factor of the zoom parameter can be set to be two (2) along different axes for the image blocks in the innermost oval enclosing the pre-set target 319 or 619. The zoom factor of the zoom parameter for the other image blocks can be gradually reduced away from the pre-set target 319 or 619 such that the number of pixels of the image 910 or 1010 after transformation decreases gradually away from the center.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A target searching device, comprising:
an image capture unit that captures and outputs a captured image having I×J pixels;
an image display unit that displays a displayed image having M×N pixels; and
an image process unit that is coupled with the image capture unit and the image display unit, the image process unit having:
means for receiving the captured image from the image capture unit and selecting a pre-set target from the captured image;
means for dividing the captured image into a plurality of image blocks with reference to the pre-set target; and
means for resealing each image block by a set of zoom parameters to transform the captured image of I×J pixels into the displayed image of M×N pixels for display by the image display unit.

2. The device of claim 1, wherein the pre-set target is located at the center of the captured image and the captured image is divided into a plurality of rectangular image blocks by drawing vertical lines on both sides of the pre-set target and horizontal lines over and under the pre-set target.

3. The device of claim 2, further including means for gradually reducing zoom factors of the zoom parameters for the image blocks away from the pre-set target.

4. The device of claim 3, wherein the zoom factors of the zoom parameters are set to be 1 for the image block containing the pre-set target.

5. The device of claim 1, wherein the pre-set target is located at the center of the captured image, a plurality of radiating lines are drawn from the pre-set target, and a plurality of concentric ovals are drawn to encircle the pre-set target such that a plurality of fan-shaped image blocks are formed.

6. The device of claim 5, further including means for gradually reducing zoom factors of the zoom parameters for the image blocks away from the pre-set target.

7. The device of claim 6, wherein the zoom factors of the zoom parameters are set to be 2 for the image block containing the pre-set target.

8. The device of claim 1, further including an eyeball tracking unit that assists the image process unit to select the pre-set target according to the location of the user's eyeball.

9. A method of displaying an image, comprising:
acquiring a captured image having I×J pixels;
selecting a pre-set target from the captured image;
dividing the captured image into a plurality of image blocks with reference to the pre-set target;
resealing each image block by a set of zoom parameters to transform the captured image of I×J pixels into a displayed image having M×N pixels; and
displaying the displayed image.

10. The method of claim 9, further including:
locating the pre-set target at the center of the captured image; and
dividing the captured image into a plurality of rectangular image blocks by drawing vertical lines on both sides of the pre-set target and horizontal lines over and under the pre-set target.

11. The method of claim 10, further including:
gradually reducing zoom factors of the zoom parameters for the image blocks away from the pre-set target.

12. The method of claim 11, further including:
setting the zoom factors of the zoom parameters to be 1 for the image block containing the pre-set target.

13. The method of claim 9, further including:
locating the pre-set target at the center of the captured image;
drawing a plurality of radiating lines from the pre-set target; and
drawing a plurality of concentric ovals to encircle the pre-set target such that a plurality of fan-shaped image blocks are formed.

14. The method of claim 13, further including:
gradually reducing zoom factors of the zoom parameters for the image blocks away from the pre-set target.

15. The method of claim 14, further including:
setting zoom factors of the zoom parameters to be 2 for the image block containing the pre-set target.

16. The method of claim 9, further including:
selecting the pre-set target based on the location of the user's eyeball.

17. A method of processing an image, comprising:
acquiring a captured image having lxJ pixels;
selecting a pre-set target from the captured image;
dividing the captured image into a plurality of image blocks with reference to the pre-set target;
rescaling each image block by a set of zoom parameters to transform the captured image of lxJ pixels into a processed image having MxN pixels; and
outputting the processed image.

18. The method of claim 17, further including:
locating the pre-set target at the center of the captured image; and
dividing the captured image into a plurality of rectangular image blocks by drawing vertical lines on both sides of the pre-set target and horizontal lines over and under the pre-set target.

19. The method of claim 18, further including:
gradually reducing zoom factors of the zoom parameters for the image blocks away from the pre-set target.

20. The method of claim 19, further including:
setting the zoom factors of the zoom parameters to be 1 for the image block containing the pre-set target.

21. The method of claim 17, further including:
locating the pre-set target at the center of the captured image;
drawing a plurality of radiating lines from the pre-set target; and
drawing a plurality of concentric ovals to encircle the pre-set target such that a plurality of fan-shaped image blocks are formed.

22. The method of claim 21, further including:
mgradually reducing zoom factors of the zoom parameters for the image blocks away from the pre-set target.
